(19) United States
(12) Patent Application Publication
(10) Pub. No.: US 2007/0271364 A1
(43) Pub. Date: Nov. 22, 2007

(54) Home caring system which combines the internet, a real-time communication, and a videophone background of the invention

(76) Inventor: Shu-Ming Liu, Taipei (TW)

Correspondence Address: PRO-TECHTOR INTERNATIONAL SERVICES, 20775 NORADA CT., SARATOGA, CA, 95070, US

(21) Appl. No.: 11/439,496

(22) Filed: May 22, 2006

(51) Int. Cl. G06F 15/173

(52) U.S. Cl. 709/223

(57) ABSTRACT

A home caring system which combines the internet, a real-time communication and a videophone utilizes a wireless transceiver module, wireless telephone handsets, computer-related equipment, external equipment, and a radio communication module to set up a wireless network system at home for transmitting voices and images to the computer-related equipment. In addition, the computer-related equipment is installed with a real-time communication system, in order to look after children and seniors at home and to serve as a surveillance system such that home caring and working on a job can be taken care of at the same time.

### BACKGROUND OF THE INVENTION

(a) Field of the Invention

The present invention relates to a home caring system which combines the internet, a real-time communication and a videophone, and more particularly to a home caring system which utilizes a technology platform of network structure, video transmission, and real-time communication to solve a problem that home caring and working on a job are not easy to be taken care of at the same time.

(b) Description of the Prior Art

As daily activities of children and seniors at home cannot be looked after at the same in a current home environment, house accidents will occur. On the other hand, many employees of a modern enterprise have to leave their offices frequently due to their job functions, thereby being unable to use telephones on office desks to communicate. Following a prosperous development of the internet, a requirement of using networks to provide services is also increased daily. However, there has not yet been a system of equipment which can provide occupational personnel to look after the children and seniors at home while he or she is working.

### SUMMARY OF THE INVENTION

The primary object of present invention is to provide a system with which a user can sit in front of computer-related equipment at home to communicate with other device through an earphone and a microphone on the computer.

Another object of the present invention is to provide a system such that family members can use wireless telephone handsets to serve as an indoor intercom system, through a wireless network system environment at home. For example, while a user is in a kitchen, she can still be aware of conditions of children and seniors in bed rooms, and the children and seniors can also conduct a two-way communication with the mother, thereby preventing a danger at home.

Still another object of the present invention is to provide a system such that a family member in an office can still look after the children and seniors at home through external equipment which receives and outputs the internet data by a connection of the internet with a real-time communication system. In addition, other dead angles in the care can be even reduced.

Yet still another object of the present invention is to provide a system such that when a family member is out, he or she can still look after the children and seniors at home, through an assembly of radio communication module with an urban wireless or network system.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system structure diagram of the present invention which is combined with the internet, a real-time communication, and a videophone.

FIG. 2 shows an architectural diagram of usage status of the present invention which is combined with the internet, a real-time communication, and a videophone.

### DETAILED DESCRIPTION OF THE PREFERRED EMBODIMENTS

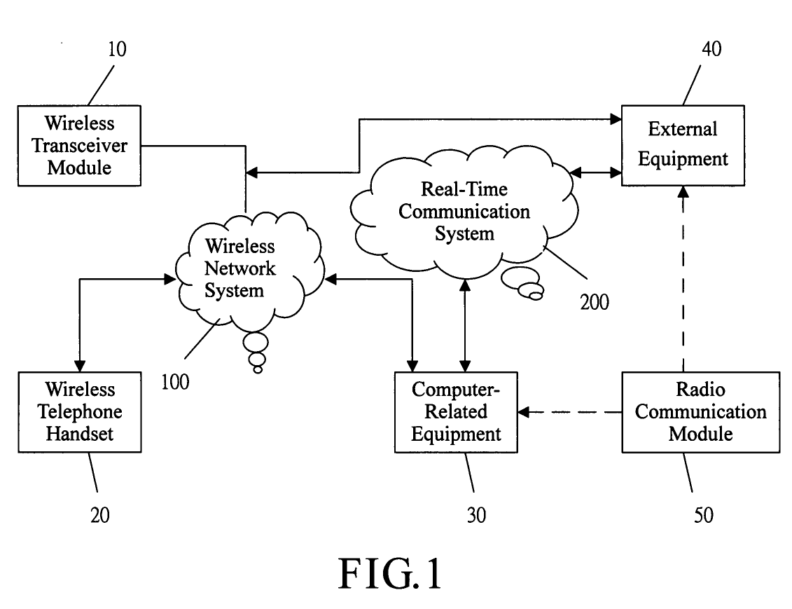

Referring to FIG. 1, a home caring system of the present invention includes a radio transceiver module 10 to be used by children and seniors at home, wireless telephone handsets 20 which are used at home, computer-related equipment 30 which are used at home for receiving and outputting data, external equipment (such as computer-related equipment) 40 outside of the home which can receive and output the internet data, and a radio communication module 50, such as all kinds of cellular phones, and PDAs (Personal Digital Assistants) which are provided with a function of browsing the internet.

First of all, a set of wireless network system 100 is built at a home to transmit voices and images to the computer-related equipment 30, using for example the Blue Tooth short range wireless transmission, the Digital Enhanced Cordless Telecommunication (DECT), the WIFI (Wireless Fidelity) or the UWB (Ultra-Wideband) system. A requirement of interconnected application using the DECT standard to assemble with an e-mail, a fax, and the PDA has been gradually formed, by utilizing the advantages of DECT standard including that voice quality is clearer after being digitally processed, a transmission range is enlarged, DECT standard is broadly applied to homes and enterprises, and a high density communication is used without being subjected to interference.

Next, a real-time communication system 200, such as the SKYPE, MSN MESSENGER, AOL (America On-Line), ICQ (I Seek You), or other self-developed dedicated application system, is installed on the computer-related equipment 30, to be connected with a network facility outside of the home and the external computer-related equipment 40; wherein the popular MSN MESSENGER is a most primitive type of network telephone which can be used to conduct an ordinary two-way computer-to-computer dialog by installing the dialog software, an earphone, and a microphone on the computer.

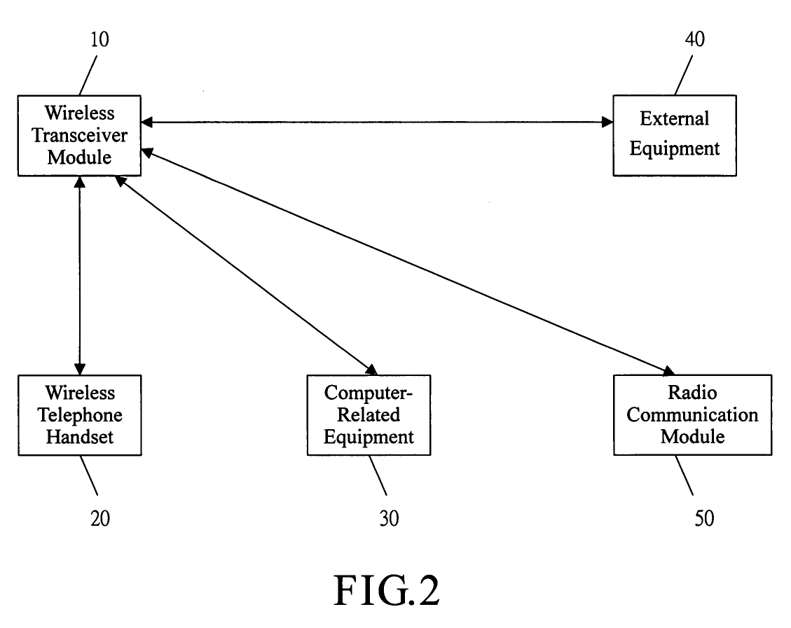

Referring to FIG. 2, states of utilization of the system of present invention include:
1. A user can sit in front of the computer-related equipment 30 at home to communicate with other device through the earphone and microphone on the computer.
2. Through the wireless network system 100 environment at home, family members can use the wireless telephone handsets 20 as an indoor intercom system. For example, if the user is in a kitchen, she can still be aware of conditions of children and seniors in be rooms, and the children and seniors can also conduct a two-day dialog with the mother, thereby preventing a danger at home.
3. Through a connection of the internet and real-time communication system 200, a family member in an office can still look after the children and seniors at home through the external equipment 40 which receives and outputs the internet data. In addition, other dead angles in the care can be even reduced.
4. When a family member is out, he or she can still look after the children and seniors at home, through an assembly of the radio communication module 50 with an urban wireless or network system.
5. This architecture can be also applied to a home security surveillance, wherein the wireless transceiver module 10 at home, the computer-related equipment 30 which receives and outputs data at home, and the external equipment 40 which receives and outputs the internet data can be added with a photographing device (such as a camera) which can store voices and images occurred at home into the computer-related equipment 30 and the external equipment 40, or transmit to the radio communication module 50 like a cellular phone.

Accordingly, due to that the technologies of network architecture, image transmission, and real-time communication are gradually matured, the present invention can utilize this platform to solve the problem that home caring and working on a job are not easy to be taken care of at the same time.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A home caring system which combines the internet, a real-time communication and a videophone comprising a radio transceiver module which is used by children and seniors at home to receive and transmit messages from and to a communication end; a wireless telephone handset which is used at home to serve as an indoor intercom system; computer-related equipment which is used at home to receive and output voice signals and image signals, as well as to transmit messages with the radio transceiver module; external equipment which can be communicated with the radio transceiver module and the computer-related equipment by receiving and outputting the internet data; and a radio communication module which can be communicated with the computer-related equipment and the external equipment with a cellular phone and a PDA which is provided with a function of browsing the internet.

2. The home caring system which combines the internet, a real-time communication and a videophone according to claim 1, wherein the home is installed with a wireless network system which can transmit voices and images to the computer-related equipment.

3. The home caring system which combines the internet, a real-time communication and a videophone according to claim 1, wherein the computer-related equipment is installed with a real-time communication system to be connected with an external network facility outside of the home, and external computer-related equipment.

4. The home caring system which combines the internet, a real-time communication and a videophone according to claim 1, wherein the radio transceiver module is provided with a photographing device.

5. The home caring system which combines the internet, a real-time communication and a videophone according to claim 1, wherein the computer-related equipment is provided with a photographing device.

6. The home caring system which combines the internet, a real-time communication and a videophone according to claim 1, wherein the external equipment is provided with a photographing device.
